(19) United States
(12) Patent Application Publication
(10) Pub. No.: US 2025/0379450 A1
(43) Pub. Date: Dec. 11, 2025

(54) OPTIMIZED CONTROL METHOD FOR POWER DISTRIBUTION SCHEDULING IN A MICROGRID CONTROLLER

(71) Applicant: Caterpillar Inc., Peoria, IL (US)

(72) Inventors: Sowmya NAGESH, Peoria, IL (US); Gregory Scott HASLER, Pekin, IL (US); Ronald Christopher GAYLES, Peoria, IL (US)

(73) Assignee: Caterpillar Inc., Peoria, IL (US)

(21) Appl. No.: 18/736,080

(22) Filed: Jun. 6, 2024

(51) Int. Cl. H02J 3/46; H02J 3/00; H02J 3/32; H02J 3/38; H02J 7/00

(52) U.S. Cl. CPC H02J 3/466; H02J 3/003; H02J 3/32; H02J 3/381; H02J 3/388; H02J 7/0048; H02J 7/00712; H02J 2203/10

(57) ABSTRACT

A microgrid controller of a microgrid includes one or more memories configured to store a power distribution schedule comprising a plurality of time segments; a communication interface configured to receive energy resource information corresponding to a plurality of energy resource systems connected to the microgrid, and output control signals for controlling an operation of each energy resource system of the plurality of energy resource systems; and one or more processors, coupled to the one or more memories, configured to: monitor a current time to determine a current time segment among the plurality of time segments; and generate the control signals based on the current time segment within the power distribution schedule to dynamically control the operation of each energy resource system of the plurality of energy resource systems.

### TECHNICAL FIELD

The present disclosure relates generally to microgrids and, for example, to a microgrid controller configured to control or manage an operation of a microgrid.

### BACKGROUND

A microgrid is a self-sufficient energy system that serves a particular geographic area, such as a college campus, a hospital complex, a business center, a neighborhood, a mining site, a drilling site, and/or the like. Within a microgrid are one or more kinds of distributed energy resources (DERs) (e.g., solar panels, wind turbines, fuel cells, photovoltaic (PV) cells, generators, energy storage devices (e.g., batteries, capacitors, etc.), and/or other energy sources) that produce power for the microgrid. Some microgrids are configured as off-grid electrical power distribution systems (e.g., stand-alone microgrids or islands) that do not connect to a larger electrical power distribution system (e.g., a macrogrid) run by, for example, an electric utility or power plant. Some microgrids are able to operate in a grid-connected mode and in a stand-alone mode. In a grid-connected mode, a microgrid may operate connected to and synchronous with the larger electrical power distribution system. In a stand-alone mode, the microgrid may be disconnected from the larger electrical power distribution system and operate as a stand-alone microgrid. A microgrid controller may control whether the microgrid operates in the grid-connected mode or in the stand-alone mode, for example, based on a schedule or based on one or more conditions being satisfied.

Scheduling different dispatch schemes for a microgrid can be a resource drain on system resources (e.g., processor resources, such as processing bandwidth, of the microgrid controller) and could potentially slow down issuing the dispatch schemes. For example, when setting up schedules for yearly and daily operation cycles, the processing required for scheduling and dispatching various energy resource combinations that have to be created, saved, and executed can be complicated and processing intensive.

U.S. Patent Application Publication No. US2019/0156438 A1 (“the '438 publication”) discloses an Energy Management Layer (EML) that optimizes a production schedule for the performance of at least one task by at least one production unit. In the '438 publication, the EML integrates factories into a smart grid by optimizing production schedules according to smart grid conditions, including time varying energy price information from a utility reflecting a unit cost of energy for a pre-determined time period in a near future timeframe. The production schedule is optimized at least in part by the time varying energy price information to minimize costs and enhance smart grid engagement, and occurs during a time window taking into account the periodic schedule of energy prices. However, the '438 publication does not disclose a seed schedule that is adapted to optimize resource utilization for power dispatch schedulers in microgrid controllers.

The microgrid controller of the present disclosure solves one or more of the problems set forth above and/or other problems in the art. For example, the microgrid controller may execute an optimized power dispatch (distribution) schedule that enables more efficient dispatch schemes and faster implementation of the dispatch schemes. The microgrid controller may derive the optimized power dispatch schedule from a seed power dispatch schedule such that processor resources used for dispatch scheduling are reduced during dispatch scheduling and execution.

### SUMMARY

In some implementations, a microgrid controller of a microgrid includes one or more memories configured to store a power distribution schedule comprising a plurality of time segments; a communication interface configured to receive energy resource information corresponding to a plurality of energy resource systems connected to the microgrid, and output control signals for controlling an operation of each energy resource system of the plurality of energy resource systems; and one or more processors, coupled to the one or more memories, configured to: monitor a current time to determine a current time segment among the plurality of time segments; and generate the control signals based on the current time segment within the power distribution schedule to dynamically control the operation of each energy resource system of the plurality of energy resource systems, including: assigning, based on the current time segment, each energy resource system of the plurality of energy resource systems to a plurality of groups, including a first group of energy resource systems and a second group of energy resource systems, generating, based on the current time segment, one or more first control signals to enable the first group of energy resource systems among the plurality of energy resource systems to supply power to the microgrid, and generating, based on the current time segment, one or more second control signals to disable the second group of energy resource systems among the plurality of energy resource systems from supplying power to the microgrid.

In some implementations, a control method includes executing a power distribution schedule comprising a plurality of time segments; receiving energy resource information corresponding to a plurality of energy resource systems associated with a microgrid; monitoring a current time relative to the power distribution schedule to determine a current time segment among the plurality of time segments; assigning, based on the current time segment, each energy resource system of the plurality of energy resource systems to a plurality of groups, including a first group of energy resource systems and a second group of energy resource systems; generating, based on the current time segment, one or more first control signals to enable the first group of energy resource systems among the plurality of energy resource systems to supply power to the microgrid; and generating, based on the current time segment, one or more second control signals to disable the second group of energy resource systems among the plurality of energy resource systems from supplying power to the microgrid.

In some implementations, a scheduling method includes prompting, by a human-machine interface, a selection of a first power distribution schedule as a seed schedule; providing, by the human-machine interface, a schedule identifier of the first power distribution schedule to a microgrid controller; extracting, by the microgrid controller, the first power distribution schedule from a schedule database based on the schedule identifier; copying, by the microgrid controller, the first power distribution schedule as a second power distribution schedule; reconfiguring, by the microgrid controller, the second power distribution schedule based on one or more operation parameters to generate a third power distribution schedule that includes a plurality of time segments with defined energy resource allocations for each time segment; assigning, by the microgrid controller, based on a current time segment of the third power distribution schedule, each energy resource system of a plurality of energy resource systems to a plurality of groups, including a first group of energy resource systems and a second group of energy resource systems; generating, by the microgrid controller, based on the current time segment, one or more first control signals to enable the first group of energy resource systems among the plurality of energy resource systems to supply power to a microgrid; and generating, by the microgrid controller, based on the current time segment, one or more second control signals to disable the second group of energy resource systems among the plurality of energy resource systems from supplying power to the microgrid.

### BRIEF DESCRIPTION OF THE DRAWINGS

FIG. 1 shows a system according to one or more implementations.

FIG. 2 shows a microgrid according to one or more implementations.

FIG. 3 is a flowchart of an example process associated with optimized control method for power distribution scheduling in a microgrid controller.

FIG. 4 is a flowchart of an example process associated with a scheduling method for power distribution scheduling in a microgrid.

FIG. 5 is a diagram of example components of a microgrid controller associated with an optimized control method for power distribution scheduling in the microgrid controller.

### DETAILED DESCRIPTION

This disclosure relates to a power distribution system, and is applicable to any system that distributes and/or receives power via a power grid. Some aspects relate to a microgrid controller that is configured to control one or more components and/or systems associated with the microgrid, including energy resource systems and/or loads. The microgrid controller may control a state of the microgrid based on one or more conditions being satisfied.

The microgrid controller executes a power distribution schedule based on energy resource information received from a plurality of energy resource systems connected to the microgrid to dynamically manage which energy resource systems supply power to the microgrid and which energy resource systems are disabled from supplying power to the microgrid during different time segments provided in the power distribution schedule. The microgrid controller may derive the power distribution schedule from a seed power distribution schedule to reduce processor resources used to generate and execute the power distribution schedule. A reduction in processor resources may enable the microgrid controller to dispatch instructions to one or more energy resource systems in a faster and more efficient manner to ensure a more efficient operation of the microgrid, including a more efficient distribution of power to one or more loads. These loads can be active (real) or reactive to allow for a power quality-based approach to scheduling.

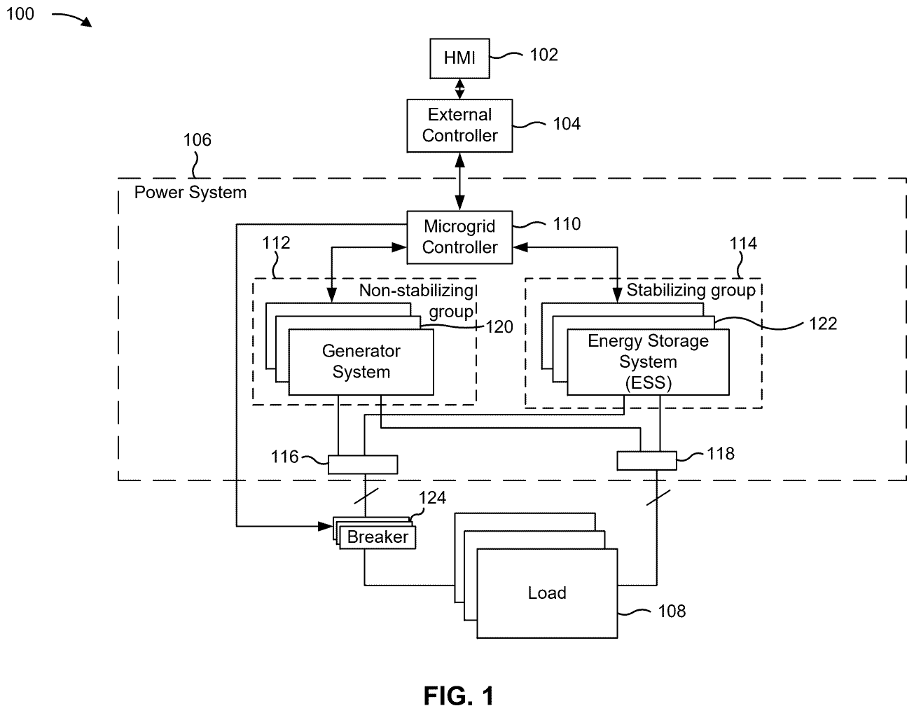

FIG. 1 shows a system 100 according to one or more implementations. The system 100 may include a human-to-machine interface (HMI) 102, an external controller 104, a power system 106, and one or more loads 108.

The power system 106 may be a microgrid or other type of electrical power distribution system that may provide power to the one or more loads 108. In some cases, the power system 106 may be an off-grid electrical power distribution system. In some cases, the power system 106 may be configurable to operate in a grid-connected mode and in a stand-alone mode. The power system 106 may include a microgrid controller 110, a non-stabilizing group of energy resource systems 112 (e.g., a non-stabilizing group of DERs), a stabilizing group of energy resource systems 114 (e.g., a stabilizing group of DERs), and interfaces 116 and 118. Generally, “off-grid” may mean that the electrical power distribution system is not connected to a larger electrical power distribution system run by, for example, an electric utility or other large-scale electric power generation plant that serves electricity to a geographic area, campus, compound, etc. However, techniques disclosed herein may still be applied to electrical power distribution systems that are connected to larger electrical power distribution systems. For instance, the larger electrical power distribution systems may operate as a power source in a primary provider role or secondary provider role, while the power system 106 may operate as a power source in the other of the primary provider role or secondary provider role.

The non-stabilizing group of energy resource systems 112 may include one or more energy generator systems 120. Each energy generator system 120 may include a power generator (e.g., an engine-generator, a fuel cell, a PV cell, or other power generating system) and a local generator controller communicatively coupled to the microgrid controller 110. Thus, each energy generator system 120 may generate power from a respective power source. Each local generator controller may control how much power a respective power generator generates, control a rate of power distribution, and/or obtain status information corresponding to the respective power generator. Each local generator controller may be controlled by the microgrid controller 110.

The stabilizing group of energy resource systems 114 may include one or more energy storage systems (ESSs) 122. Each energy storage system 122 may include an electric storage device (e.g., one or more batteries and/or capacitors) and a local ESS controller communicatively coupled to the microgrid controller 110. Each local ESS controller may control a flow of power into or out of a respective electric storage device, including charging of the respective electric storage device and discharging of the respective electric storage device, control a rate of power flow, and/or obtain status information corresponding to the respective electric storage device, such as state-of-charge (SOC), state-of-health (SOH), discharge limit, and other device parameters. Each local ESS controller may be controlled by the microgrid controller 110.

The system 100 may also include one or more breakers 124 (e.g., distribution breakers or switches) that may be individually controlled by the microgrid controller 110 to connect a respective load 108 to the power system 106 or disconnect the respective load 108 from the power system 106. The one or more breakers 124 may be part of one or both interfaces 116 and 118.

The HMI 102 may include one or more processors, and may be configured to receive and process one or more inputs from a user, such as an operator. Additionally, the HMI 102 may be configured to provide one or more prompts or outputs to the user. Thus, the HMI 102 may be a user terminal configured to interact with a user to process information and/or commands provided by the user, provide information to the user (e.g., status information), and/or perform one or more tasks or functions in response to processing the information and/or commands provided by the user. The HMI 102 may be communicatively coupled to the external controller 104, which may be communicatively coupled to the microgrid controller 110. In some implementations, the HMI 102 may be communicatively coupled directly to the microgrid controller 110. The external controller 104 may send commands to and receive information from the microgrid controller 110. For example, the external controller 104 may send commands to the microgrid controller 110 based on information received from the HMI 102. Thus, the external controller 104 may be a user-commanded controller. The external controller 104 may be integrated with the HMI 102. The external controller 104 may be a controller of a larger electrical power distribution system (e.g., a macrogrid, a power generation plant, and/or electric utility provider).

The power system 106 may provide electrical power to the one or more loads 108. Generally, the power system 106 may provide alternating current (AC) power at a particular voltage and a particular current. The microgrid controller 110 may control one or more energy storage systems 122 to instantaneously inject power when power is needed by the power system 106 or instantaneously absorb surplus power generated by the power system 106. Accordingly, one of more electric storage devices of the energy storage systems 122 may act as a power consumer on one or more energy generator systems 120 or as a power source for the one or more energy generator systems 120, to thereby ensure that system bus frequencies of the non-stabilizing group of energy resource systems 112 are maintained at a nominal value. In other words, the microgrid controller 110 may control the stabilizing group of energy resource systems 114 to stabilize loads of the non-stabilizing group of energy resource systems 112 in order to maintain the non-stabilizing group of energy resource systems 112 at a relatively constant load, which may reduce a recurrence of frequency deviations from the nominal value.

The microgrid controller 110 may be integrated with, or separate from (but connected to), the interfaces 116 and 118, the energy generator systems 120, and the energy storage systems 122, or combinations thereof. In this manner, a user may, through interaction with the HMI 102, add or remove energy generator systems 120 to increase/reduce system power generation and/or add or remove energy storage systems 122 to increase/reduce system energy storage capacity, in accordance with a user's preference. For instance, a user may prefer to add additional energy generator systems 120 and/or add additional energy storage systems 122 to increase load capacity if additional loads 108 are expected to be connected to the power system 106, or remove energy generator systems 120 and/or remove energy storage systems 122 to decrease load capacity if loads 108 are expected to be disconnected from the power system 106. Additionally, the microgrid controller 110 may be configured to add or remove energy generator systems 120 and/or add or remove energy storage systems 122 from the power system 106 based one or more conditions being satisfied. In some cases, the microgrid controller 110 may be configured to add or remove energy generator systems 120 and/or add or remove energy storage systems 122 from the power system 106 based on a schedule.

The one or more loads 108 may be any device that can connect to a power distribution system, such as the power system 106, to receive electrical power. Examples of loads may include heavy machinery (e.g., electric mining machines, haulers, etc.), personal devices, appliances, heating, ventilation, and air conditioning (HVAC) systems, industrial drills, personal residence electrical distribution systems, etc. The loads 108 may include one or more non-stable loads, such as one or more cyclic loads. The loads 108 may include unidirectional loads (e.g., loads that can only receive power from the power system 106), bi-directional loads (e.g., loads that can both receive power from the power system 106 and provide power to the power system 106), charging loads (e.g., loads that include a chargeable electric battery), essential loads (e.g., loads that require uninterrupted service), and/or non-essential loads (e.g., loads that do not require uninterrupted service). Loads may be assigned different priorities based on load type, load classification, and/or operation state or mode.

Generally, the one or more loads 108 may receive the power from the power system 106 and use the power in accordance with the operations of the one or more loads 108. Users of the power system 106 and the one or more loads 108 may connect/disconnect the one or more loads 108 by electrically connecting the one or more loads 108 to the interfaces 116 and 118 of the power system 106. For instance, the interfaces 116 and 118 may have AC plugs/sockets to connect the one or more loads 108 in parallel to the one or more energy generator systems 120 and the one or more energy storage systems 122 of the power system 106. One or more loads 108 may include a local load controller that may collect load information and transmit the load information to the microgrid controller 110. Load information may include information indicating a load type, a load classification, and/or an operation state or mode of a load 108. The loads can be active (real) or reactive to allow for a power quality-based approach to scheduling. Load information may include load data of a load, such as maximum load and minimum load. For chargeable loads, load information may include maximum charging load, maximum state of charge, minimum state of charge, current state of charge, and usable discharge energy as a function of the current state of charge. Load information may be received by the microgrid controller 110 via the interfaces 116 and 118, which may include one or more communication interfaces coupled to the microgrid controller 110.

The interfaces 116 and 118 may also have a plurality of generator connections and a plurality of energy store connections. The plurality of generator connections may be hardwired electrical connections and/or AC plugs/sockets to connect the one or more energy generator systems 120 in parallel to the at least one load 108 and the one or more energy storage systems 122. The plurality of energy store connections may be hardwired electrical connections and/or AC plugs/sockets to connect the one or more energy storage systems 122 in parallel to the one or more loads 108 and the one or more energy generator systems 120. For instance, the power system 106 may or may not allow addition/removal of energy generator systems 120 and/or addition/removal of energy storage systems 122. Therefore, depending on a configuration, the interfaces 116 and 118 may include: (1) hardwired electrical connections that connect the at least one energy generator system 120; (2) AC plugs/sockets to connect/disconnect the at least one energy generator system 120; (3) hardwired electrical connections that connect the at least one energy storage system 122; and/or (4) AC plugs/sockets to connect/disconnect the at least one energy storage system 122. The interfaces 116 and 118 may be coupled to a system bus (e.g., a power bus) of the power system 106. The system bus may enable one of more of the energy storage systems 122 to absorb power from one or more energy generator systems 120 and/or one or more loads 108 (e.g., for charging and/or storing power).

The one or more energy generator systems 120 may also include communication interfaces. The communication interfaces of the one or more energy generator systems 120 may enable the one or more energy generator systems 120 to communicate with the microgrid controller 110. For instance, the one or more energy generator systems 120 may be connected to the microgrid controller 110 by wired or wireless communication. The one or more energy generator systems 120 may provide the microgrid controller 110 with generator data. The generator data, for each of the one or more energy generator systems 120, may include load data and/or generator parameters. The load data may include a current (e.g., instantaneous) load seen by the one or more energy generator systems 120 and/or past load data (if one or more energy generator systems 120 store such data locally). The current load/past load data may include voltage (e.g., in volts) and/or current (e.g., in amperes) measured by one or more sensor components included in an energy generator system 120. The generator parameters may include a generator set maximum threshold value and a generator set minimum threshold value. Alternatively, to reduce transmission bandwidth, the generator data may omit the generator parameters, and the one or more energy generator systems 120 may transmit the generator parameters during an initial configuration process between the one or more energy generator systems 120 and the microgrid controller 110. The generator set maximum threshold value and the generator set minimum threshold value may indicate a maximum power load and a minimum power load, respectively, that a generator of an energy generator system 120 may support.

The one or more energy storage systems 122 may be any energy storage device that can store and output AC power. For instance, the one or more energy storage systems 122 may include at least one electrical-chemical energy storage (e.g., a battery), electrical energy storage (e.g., a capacitor, a supercapacitor, or a superconducting magnetic energy storage), mechanical energy storage (e.g., a fly wheel, a pump system), and/or any combination thereof. The one or more energy storage systems 122 may include inverters (individually or collectively) so that the one or more energy storage systems 122 may operate as a power consumer or a power source. The one or more energy storage systems 122 may also include electronic control mechanisms to control (1) how much load the one or more energy storage systems 122 draw, or (2) how much AC power the one or more energy storage systems 122 output.

The one or more energy storage systems 122 may also include communication interfaces. The communication interfaces of the one or more energy generator systems 120 may enable the one or more energy storage systems 122 to communicate with the microgrid controller 110. For instance, the one or more energy storage systems 122 may be connected to the microgrid controller 110 by wired or wireless communication. The one or more energy storage systems 122 may provide the microgrid controller 110 with energy storage data and may receive instructions from the microgrid controller 110.

The energy storage data may include, for each of the at least one energy store, a current energy level (e.g., kilowatt-hours currently stored), total energy storage capacity (e.g., kilowatt-hours of capacity), and/or discharge/charge parameters. The current energy level may be measured by a battery meter of an energy storage. The battery meter may one or combinations of a voltmeter, an amp-hour meter, and/or an impedance-based meter. The discharge/charge parameters may indicate an amount of discharge power and an amount of charge power for a respective energy storage device of the one or more energy storage systems 122. Alternatively, to reduce transmission bandwidth, the energy storage data may omit the discharge/charge parameters, and the one or more energy storage systems 122 may transmit the discharge/charge parameters when the one or more energy storage systems 122 are first connected to the microgrid controller 110.

The one or more energy storage systems 122 may receive requests (e.g., instructions) for the energy storage data to provide the energy storage data and/or continuously provide the energy storage data to the microgrid controller 110. The instructions may include energy storage dispatch (ESD) instructions. An ESD instruction may include an instruction to inject power to a system bus of the power system 106 or absorb power from the system bus of the power system 106. ESD instructions may be provided in control signals (e.g., communication signals that provide the ESD instructions). At least one ESD instruction may be utilized to rapidly stabilize the load, thereby stabilizing the bus frequency of the power system 106 in a time efficient manner, rather than attempting to stabilize the load using the one or more energy generator systems 120 alone. The one or more energy storage systems 122 may control the inverters and the electronic control mechanisms to control (1) quantity of load drawn by the one or more energy storage systems 122, or (2) the amount of AC power output produced by the one or more energy storage systems 122, in accordance with the ESD instructions.

The microgrid controller 110 may include at least one memory device (e.g., one or more memories) for storing instructions (e.g., program code); at least one processor for executing the instructions from the memory device to perform a set of desired operations; and a communication interface (e.g., coupled to a communication bus) for facilitating the communication between various system components. The instructions may be computer-readable instructions for executing a control application. The communication interface of the microgrid controller 110 may enable the microgrid controller 110 to communicate with the one or more energy generator systems 120 and the one or more energy storage systems 122. The microgrid controller 110, while executing the control application, may receive the generator data and the energy storage data (e.g., energy resource information), process the generator data and the energy storage data to generate one or more ESD instructions, and output the ESD instructions to one or more energy generator systems 120 and/or to one or more energy storage systems 122. To process the generator data and the energy storage data to generate the ESD instructions, the control application may refer to a power distribution schedule, stored in the one or more memories, to manage operating states of the energy resource systems (e.g., DERs).

The one or more energy storage systems 122 may control the inverters and the electronic control mechanisms of the one or more energy storage systems 122 to control (1) how much load the one or more energy storage systems 122 draw, or (2) how much AC power the one or more energy storage systems 122 output, in accordance with the transmitted ESDs. In addition, one or more energy generator systems 120 may control how much AC power the one or more energy generator systems 120 output, in accordance with the transmitted ESDs.

The microgrid controller 110 may perform the process over again (for example, for each time segment provided in the power distribution schedule).

Moreover, the systems and methods of the present disclosure may drive the SOC of one or more energy storage systems 122 to a target SOC so that each energy storage system 122 is not maintained in a too low or too high SOC.

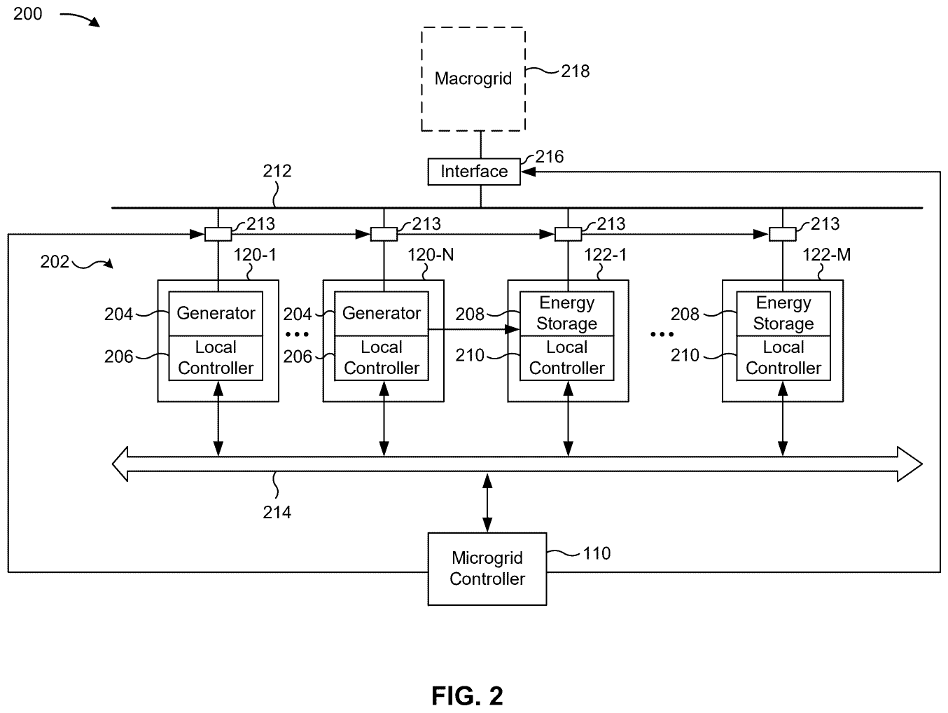

FIG. 2 shows a microgrid 200 according to one or more implementations. The microgrid 200 may be an example of the power system 106 described in connection with FIG. 1. The microgrid 200 may include a plurality of DERs 202. The plurality of DERs 202 may include N energy generator systems 120 and M energy storage systems 122, where N and M are integers greater than zero. For example, the plurality of DERs 202 may include a first energy generator system 120-1 and an Nth energy generator system 120-N. Additionally, the plurality of DERs 202 may include a first energy storage system 122-1 and an M^{th} energy storage system 122-M. Each energy generator system 120 may include a power generator 204 and a local generator controller 206. Each energy storage system 122 may include an electric storage device 208 (e.g., one or more batteries and/or capacitors) and a local ESS controller 210.

Each energy generator system 120 may be coupled to a power bus 212 for providing power to one or more loads connected to the power bus 212. Additionally, each energy storage system 122 may be coupled to the power bus 212 for providing power to or absorbing power from the power bus 212 (e.g., for providing power to or absorbing power from one or more components, such as one or more loads and/or one or more energy generator systems 120 connected to the power bus 212).

The microgrid 200 may also include the microgrid controller 110 that is communicatively coupled to the local controllers (e.g., local generator controllers 206 and local ESS controllers 210) of each DER 202 across a communication bus 214. The communication bus 214 may also enable the microgrid 200 to communicate with one or more loads and/or one or more load management systems (e.g., charging systems, fleet management systems, local load controllers, etc.). In some cases, two or more communication buses 214 may be provided. For example, one communication bus may be provided to communicate with local controllers and another communication bus may be provided to communicate with one or more loads and/or one or more load management systems.

Each local generator controller 206 may include any appropriate hardware, software, and/or firmware to sense and control a respective power generator 204, and send information to, and receive information from microgrid controller 110. For example, a local generator controller 206 may be configured to sense, determine, and/or store generator data of its respective power generator 204. The generator data may be sensed, determined, and/or stored in any conventional manner. Each local generator controller 206 may control whether a respective power generator 204 is connected to or disconnected from the power bus 212 (for example, based on an instruction or a control signal received from the microgrid controller 110).

Each local ESS controller 210 may include any appropriate hardware, software, and/or firmware to sense and control a respective electric storage device 208, and send information to, and receive information from microgrid controller 110. For example, a local ESS controller 210 may be configured to sense, determine, and/or store various characteristics of its respective electric storage device 208. Such characteristics of the respective electric storage device 208 may include, among others, a current SOC, a current energy, an SOC minimum threshold, an SOC maximum threshold, and a discharge limit of the respective electric storage device 208. These characteristics of respective electric storage device 208 may be sensed, determined, and/or stored in any conventional manner. Each local ESS controller 210 may control whether a respective electric storage device 208 is connected to or disconnected from the power bus 212 (for example, based on an instruction or a control signal received from the microgrid controller 110).

The microgrid controller 110 may receive or determine a need for charging or discharging of power from the microgrid 200, and may be configured to determine and send signals to allocate a total charge request and/or total discharge request across all of the plurality of DERs 202.

When performing the power allocation functions, the microgrid controller 110 may allocate a certain amount of power from each energy generator system 120 to one or more loads. When performing the power allocation functions, the microgrid controller 110 may allocate a total charge request and/or a total discharge request across the energy storage systems 122 as a function of a usable energy capacity of each energy storage system 122. The usable energy capacity corresponds to the capacity or amount of energy that an energy storage system 122 can receive in response to a total charging request (usable charge energy), or the capacity or amount of energy that an energy storage system can discharge in response to a total discharge request (usable discharge energy). The usable charge energy is a function of a maximum state of charge, current state of charge, and current energy of the energy storage system, and the usable discharge energy is a function of a minimum state of charge, and current energy of the energy storage system 122. The microgrid controller 110 may determine a usable charge/discharge capacity of each energy storage system 122 (e.g., SOC), a desired charge/discharge of each energy storage system 122, a remainder power of each energy storage system 122, and/or an SOH of each energy storage system 122.

Thus, the microgrid controller 110 regulates a power supply of the microgrid 200 such that an exact amount of desired power flows in or out of the power system 106 at any given time. The microgrid controller 110 may regulate the power supply of the microgrid 200 in cooperation with the local generator controllers 206 and the local ESS controllers 210. The microgrid controller 110 may transmit control signals (e.g., instructions) to the local generator controllers 206 and the local ESS controllers 210 to activate (e.g., to bring online), deactivate (to bring offline), or curtail (limit or regulate to a target output) one or more of the DERs 202. Additionally, or alternatively, the microgrid controller 110 may transmit control signals to one or more switches 213 to control a switch state (e.g., an on state or an off state) of the one or more switches 213, for example, to connect one or more DERs 202 to or disconnect one or more DERs 202 from the microgrid 200 (e.g., the power bus 212). The switches 213 may be integrated in one or both interfaces 116 and 118 described in connection with FIG. 1.

In some cases, two or more power buses 212 may be provided. For example, a power bus may be provided to couple one or more power generators 204 to one or more electric storage devices 208 for charging the one or more electric storage devices 208. For example, the microgrid controller 110 may selectively couple a power generator 204 to an electric storage device 208 to charge the electric storage device 208. Thus, the power bus 212 may be part of a power distribution network of the microgrid 200 that may include one or more power buses used to distribute power between loads and/or DERs 202.

The microgrid 200 may include an interface 216 for connecting the microgrid 200 to and disconnecting the microgrid 200 from an electrical power distribution system 218, such as a macrogrid. The interface 216 may include one or more electrical connections used for connecting the microgrid 200 to the electrical power distribution system 218. The interface 216 may include one or more switches or breakers that are controlled by the microgrid controller 110 for connecting the microgrid 200 to and disconnecting the microgrid 200 from the electrical power distribution system 218. For example, the one or more switches or breakers of the interface 216 may connect the power bus 212 (or another system bus) to or disconnect the power bus 212 (or another system bus) from the electrical power distribution system 218. Thus, the microgrid controller 110 may configure the microgrid 200 to operate in a grid-connected mode by connecting the microgrid 200 to the electrical power distribution system 218 or in a stand-alone mode by disconnecting the microgrid 200 from the electrical power distribution system 218.

The microgrid controller 110 may store, in one of its memories, a power distribution schedule that includes a plurality of time segments. The power distribution schedule may include energy resource scheduling and/or energy resource scheduling parameters for an entire operation cycle (e.g., daily, weekly, monthly, quarterly, yearly). In some cases, an operation cycle is a single 24-hour period from 12:00 am to 11:59 pm. Thus, the plurality of time segments may be within a 24-hour period. The microgrid controller 110 may receive scheduling criteria and generate the power distribution schedule based on the scheduling criteria.

The plurality of time segments may include any number of time segments, and each time segment may include a respective start time and a respective end time. One or more time segments may be down to a one minute resolution, where the respective start time and the respective end time spans one minute. The time segments may be periodic or aperiodic, and/or continuous or discontinuous. However, the time segments are not overlapping. Thus, each time segment has a dedicated time interval during which the time segment is activated as a current time segment (e.g., based on a time of day). For example, the microgrid controller 110 may monitor a current time to determine the current time segment among the plurality of time segments. A time segment may be activated as the current time segment when the current time matches a time interval defined by the respective start time and the respective end time of the time segment. Thus, only one time segment can be the current time segment at any given time.

The microgrid controller 110 may generate control signals for controlling an operation of each DER 202 based on the current time segment to dynamically control the operation of each DER 202 as the current time progresses through the power distribution schedule. In other words, as different time segments are activated, the microgrid controller 110 may change the control signals to dynamically control the operation of each DER 202.

For example, the microgrid controller 110 may assign, based on the current time segment, each DER 202 of the plurality of DERs 202 to a plurality of groups of DERs, including a first group of DERs and a second group of DERs. The microgrid controller 110 may dynamically allocate different sets of DERs to the first group of DERs for different time segments of the plurality of time segments.

The microgrid controller 110 may receive energy resource information corresponding to the plurality of DERs 202 connected to or otherwise associated with the microgrid 200, and may use the energy resource information to make scheduling decisions based on scheduling parameters provided in a power distribution schedule. Each time segment may include a set of scheduling parameters for the microgrid controller 110 to follow during that time segment.

The microgrid controller 110 may select DERs among the plurality of DERs 202 for the first group of DERs based on an expected load demand on the microgrid 200 during the current time segment in order to satisfy the expected load demand. The microgrid controller 110 may determine an energy resource type of each DER (e.g., generator type, energy storage type, renewable energy resource, etc.) based on the energy resource information, and allocate DERs among the plurality of DERs 202 to the first group of DERs based on the energy resource type of each DER and based on energy resource type criteria specified in the current time segment of the power distribution schedule. For example, the energy resource type criteria may specify that only generator type DERs should be active, only energy storage type DERs should be active, or only renewable energy DERs should be active in a particular time segment. The microgrid controller 110 may determine an output power of each DER based on the energy resource information, and allocate DERs among the plurality of DERs 202 to the first group of DERs based on the output power of each DER and based on total output power criteria specified in the current time segment of the power distribution schedule.

Thus, the power distribution schedule may indicate an expected load condition on the microgrid 200 for each time segment of the plurality of time segments, and may allocate the DERs to the first group and the second group based on the expected load condition for the current time segment in order to satisfy the expected load condition. More generally, the power distribution schedule may indicate an expected grid condition on the microgrid 200 for each time segment of the plurality of time segments, and may allocate the DERs to the first group and the second group based on the expected grid condition for the current time segment in order to satisfy the expected grid condition.

The time segments of the power distribution schedule may also indicate whether the microgrid 200 is to be connected to or disconnected from the electrical power distribution system 218. The microgrid controller 110 may generate one or more grid control signals for controlling a connection state of the power distribution network of the microgrid 200 to the electrical power distribution system 218, including a grid-connected state, during which the power distribution network is connected to the electrical power distribution system 218 for receiving power from the macrogrid, and a stand-alone state, during which the power distribution network is disconnected from the electrical power distribution system 218. The microgrid controller 110 may configure the microgrid 200 in the grid-connected state or the stand-alone state based on the current time segment within the power distribution schedule. For example, the microgrid controller 110 may provide the one or more grid control signals to the interface 216 to control one or more connections of the power bus 212 to the electrical power distribution system 218. For the current time segment, the microgrid controller 110 may allocate the DERs to the first group and the second group based on whether the microgrid 200 is to be connected to or disconnected from the electrical power distribution system 218 (for example, in addition to the expected grid condition on the microgrid 200).

In addition, the microgrid controller 110 may generate, based on the current time segment, one or more first control signals to enable the first group of DERs among the plurality of DERs 202 to supply power to the microgrid 200. In addition, the microgrid controller 110 may generate, based on the current time segment, one or more second control signals to disable the second group of DERs among the plurality of DERs 202 from supplying power to the microgrid 200. The second group of DERs may represent a remaining group of DERs that remain after allocating one or more DERs to the first group of DERs. In some cases, a third group of DERs may be identified by the microgrid controller 110 as backup DERs for the first group of DERs. For example, the third group of DERs may be activated during the current time segment if one or more DERs of the first group of DERs fail or require recharging due to an SOC falling below an SOC threshold. Thus, the microgrid controller 110 may dynamically group the plurality of DERs 202 based on the current time segment, and generate control signals (e.g., ESD instructions) for each group.

The microgrid controller 110 may enable the first group of DERs by connecting each DER of the first group of DERs to the power distribution network of the microgrid 200 (for example, by controlling one or more respective switches 213). Additionally, the microgrid controller 110 may disable the second group of DERs by disconnecting each DER of the second group of DERs from the power distribution network of the microgrid 200 (for example, by controlling one or more respective switches 213).

The microgrid controller 110 may enable the first group of DERs by activating a power production at each DER of the first group of DERs. Additionally, the microgrid controller 110 may disable the second group of DERs by deactivating a power production at each DER of the second group of DERs.

In some implementations, the first group of DERs includes a chargeable energy storage system (e.g., an energy storage system 122). The microgrid controller 110 may monitor the SOC of the chargeable energy storage system, compare the SOC to a minimum SOC threshold, reallocate the chargeable energy storage system from the first group to the second group based on the SOC satisfying the minimum SOC threshold, and reallocate a DER from the second group to the first group based on the SOC satisfying the minimum SOC threshold. Thus, the microgrid controller 110 may ensure that the chargeable energy storage system maintains at least a minimum SOC, and may reassign the chargeable energy storage system to the second group for recharging if the SOC falls below the minimum SOC threshold. However, the power no longer provided to the microgrid 200 by the chargeable energy storage system may need to be replaced by another DER. Thus, the microgrid controller 110 may reallocate one or more DERs from the second group to the first group in order to satisfy a grid condition specified by the current time segment.

In some cases, the microgrid controller 110 may enable at least one auxiliary DER to charge the chargeable energy storage system that was reassigned to the second group based on the SOC satisfying the minimum SOC threshold. The at least one auxiliary DER may be selected from the second group, or may be part of the third group of DERs 202.

In addition, the microgrid controller 110 may, during charging, continue to monitor the SOC of the chargeable energy storage system that was reassigned to the second group. The microgrid controller 110 may compare the SOC to a maximum SOC threshold, reallocate the chargeable energy storage system from the second group to the first group based on the SOC satisfying the maximum SOC threshold, and reallocate the DER from the first group to the second group based on the SOC satisfying the maximum SOC threshold. In other words, the microgrid controller 110 may return the chargeable energy storage system that was reassigned to the second group back to the first group once the SOC of the chargeable energy storage system reaches a sufficient level, and may return the one or more DERs that were reassigned from the second group to the first group back to the second group.

In some implementations, the microgrid controller 110 may monitor the SOC of the chargeable energy storage system, compare the SOC to a minimum SOC threshold, reallocate, based on the SOC satisfying the minimum SOC threshold, the chargeable energy storage system to the second group, and enable, based on the SOC satisfying the minimum SOC threshold, at least one auxiliary DER to supply power to the microgrid 200.

As disclosed above, the microgrid controller 110 may derive the power distribution schedule from a seed schedule such that processor resources used for dispatch scheduling are reduced during dispatch scheduling and execution. In addition, the microgrid controller 110 may receive scheduling criteria and generate the power distribution schedule based on the scheduling criteria.

The HMI 102, described in FIG. 1, may prompt a selection of a first power distribution schedule as a seed schedule. For example, the HMI 102 may prompt a user to select the first power distribution schedule from a schedule database of power distribution schedules to use as the seed schedule. Once the user indicates which schedule is to be used as the first power distribution schedule (e.g., as the seed schedule), the HMI 102 may transmit a schedule identifier of the first power distribution schedule to the microgrid controller 110. The microgrid controller 110 may extract or otherwise retrieve the first power distribution schedule from the schedule database of power distribution schedules based on the schedule identifier, copy the first power distribution schedule as a second power distribution schedule, and reconfigure the second power distribution schedule based on one or more operation parameters (e.g., scheduling criteria) to generate a third power distribution schedule that includes the plurality of time segments with defined energy resource allocations for each time segment. The third power distribution schedule may be tuned from the seed schedule in order to reflect desired scheduling operations. Thus, the third power distribution schedule may be an optimized power distribution schedule that has been adapted from the seed schedule in order to reduce processing resources that may be otherwise required if generating the optimized power distribution schedule anew.

During execution of the third power distribution schedule, the microgrid controller 110 may assign, based on a current time segment of the third power distribution schedule, each DER of a plurality of DERs 202 to the plurality of groups, including the first group of DERs and the second group of DERs. Additionally, the microgrid controller 110 may generate, based on the current time segment, the one or more first control signals to enable the first group of DERs among the plurality of DERs 202 to supply power to the microgrid 200. Additionally, the microgrid controller 110 may generate, based on the current time segment, the one or more second control signals to disable the second group of DERs among the plurality of DERs 202 from supplying power to the microgrid 200. Thus, the microgrid controller 110 may dynamically allocate different sets of DERs to the first group of DERs for different time segments of the plurality of time segments.

The third power distribution schedule may enable reserve parameters to be scheduled items for an entire day or specifically for any time segment, such as a volatility factor for each intermittent asset group, and a transient load for each electrical bus. The third power distribution schedule may enable intermittent asset groups to be scheduled for any time segment, taking into account a volatility factor for each intermittent group. The third power distribution schedule may enable reserve DERs to be scheduled for any time segment to handle transient loads (kW) for various electrical buses. The third power distribution schedule may enable load smoothing (e.g., winder control) to be scheduled for any time segment. The third power distribution schedule may enable a load shed/load add function to be scheduled for any time segment. The third power distribution schedule may enable utility grid on/off, power factor limit disable, import/export limits, export kW, and/or reactive power (kVAR) dispatch to be scheduled for any time segment. The third power distribution schedule may enable operation states of the non-stabilizing group of energy resource systems 112 and the stabilizing group of energy resource systems 114 to be scheduled for any time segment. The operation states may include on, off, idle, charge only, discharge only, full power, and/or throttled power states.

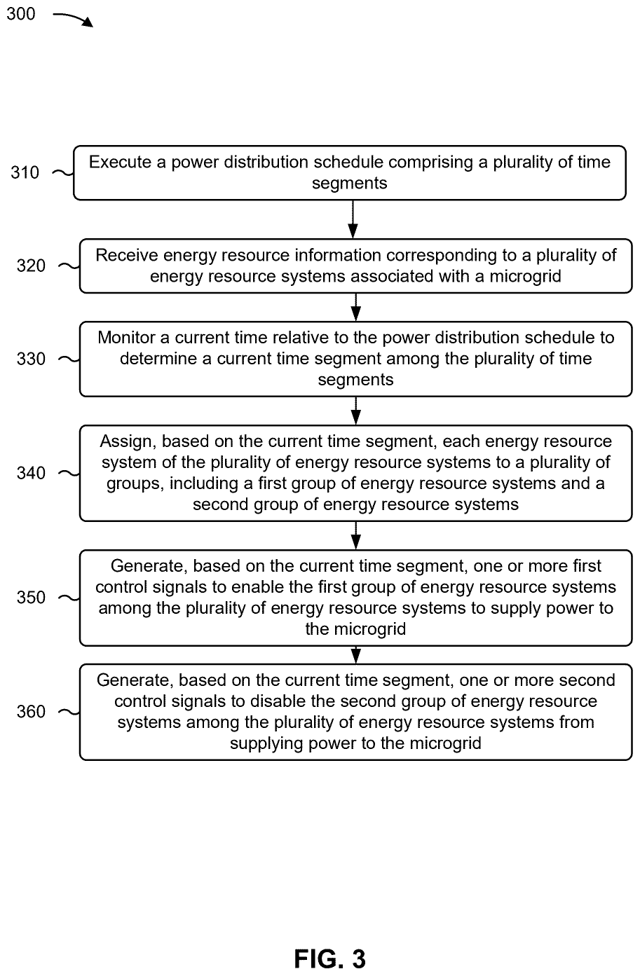

FIG. 3 is a flowchart of an example process 300 associated with an optimized control method for power distribution scheduling in a microgrid controller. One or more process blocks of FIG. 3 may be performed by a microgrid controller (e.g., microgrid controller 110). Additionally, or alternatively, one or more process blocks of FIG. 3 may be performed by another device or a group of devices separate from or including the microgrid controller, such as another device or component that is internal or external to a microgrid (e.g., microgrid 200).

Process 300 may include executing a power distribution schedule comprising a plurality of time segments (block 310); receiving energy resource information corresponding to a plurality of energy resource systems associated with a microgrid (block 320); monitoring a current time relative to the power distribution schedule to determine a current time segment among the plurality of time segments (block 330); assigning, based on the current time segment, each energy resource system of the plurality of energy resource systems to a plurality of groups, including a first group of energy resource systems and a second group of energy resource systems (block 340); generating, based on the current time segment, one or more first control signals to enable the first group of energy resource systems among the plurality of energy resource systems to supply power to the microgrid (block 350); and generating, based on the current time segment, one or more second control signals to disable the second group of energy resource systems among the plurality of energy resource systems from supplying power to the microgrid (block 360).

Although FIG. 3 shows example blocks of process 300, in some implementations, process 300 may include additional blocks, fewer blocks, different blocks, or differently arranged blocks than those depicted in FIG. 3. Additionally, or alternatively, two or more of the blocks of process 300 may be performed in parallel.

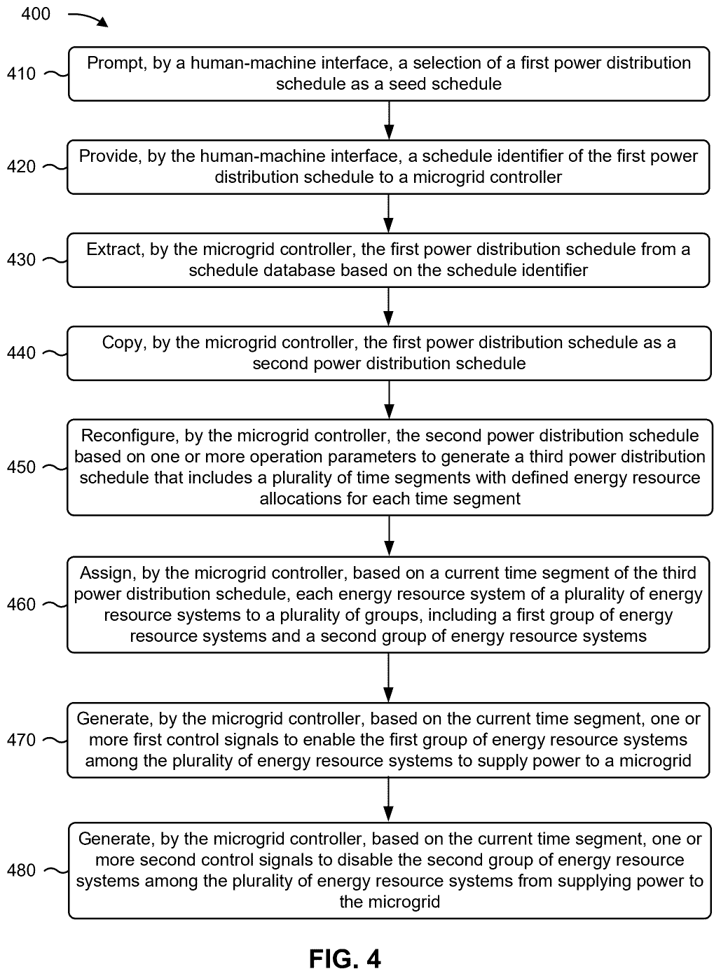

FIG. 4 is a flowchart of an example process 400 associated with a scheduling method for power distribution scheduling in a microgrid. One or more process blocks of FIG. 3 may be performed by a microgrid controller (e.g., microgrid controller 110). Additionally, or alternatively, one or more process blocks of FIG. 3 may be performed by another device or a group of devices separate from or including the microgrid controller, such as another device or component that is internal or external to a microgrid (e.g., microgrid 200).

Process 400 may include prompting, by a human-machine interface, a selection of a first power distribution schedule as a seed schedule (block 410); and providing, by the human-machine interface, a schedule identifier of the first power distribution schedule to a microgrid controller (block 420).

Additionally, process 400 may include extracting, by the microgrid controller, the first power distribution schedule from a schedule database based on the schedule identifier (block 430); copying, by the microgrid controller, the first power distribution schedule as a second power distribution schedule (block 440); reconfiguring, by the microgrid controller, the second power distribution schedule based on one or more operation parameters to generate a third power distribution schedule that includes a plurality of time segments with defined energy resource allocations for each time segment (block 450); assigning, by the microgrid controller, based on a current time segment of the third power distribution schedule, each energy resource system of a plurality of energy resource systems to a plurality of groups, including a first group of energy resource systems and a second group of energy resource systems (block 460); generating, by the microgrid controller, based on the current time segment, one or more first control signals to enable the first group of energy resource systems among the plurality of energy resource systems to supply power to a microgrid (block 470); and generating, by the microgrid controller, based on the current time segment, one or more second control signals to disable the second group of energy resource systems among the plurality of energy resource systems from supplying power to the microgrid (block 480).

Additionally, assigning each energy resource system (block 460) may include dynamically allocating, by the microgrid controller, different sets of energy resource systems to the first group of energy resource systems for different time segments of the plurality of time segments.

Although FIG. 4 shows example blocks of process 400, in some implementations, process 400 may include additional blocks, fewer blocks, different blocks, or differently arranged blocks than those depicted in FIG. 4. Additionally, or alternatively, two or more of the blocks of process 400 may be performed in parallel.

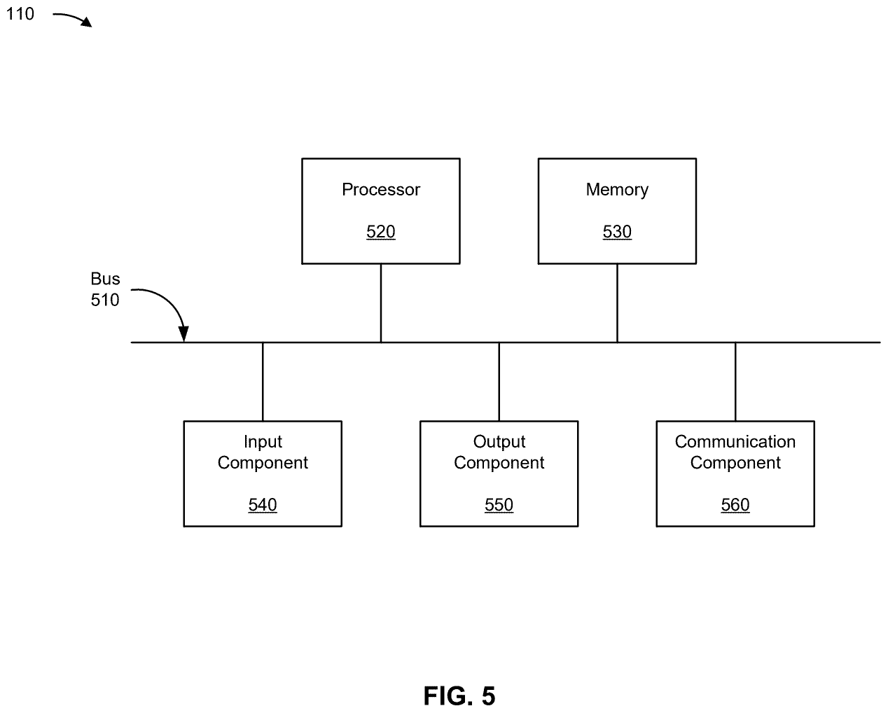

FIG. 5 is a diagram of example components of the microgrid controller 110 associated with an optimized control method for power distribution scheduling in the microgrid controller 110. The microgrid controller 110 may include a bus 510, a processor 520, a memory 530, an input component 540, an output component 550, and/or a communication component 560.

The bus 510 may include one or more components that enable wired and/or wireless communication among the components of the microgrid controller 110. The bus 510 may couple together two or more components of FIG. 5, such as via operative coupling, communicative coupling, electronic coupling, and/or electric coupling. For example, the bus 510 may include an electrical connection (e.g., a wire, a trace, and/or a lead) and/or a wireless bus.

The processor 520 may include a central processing unit a microprocessor, a controller, a microcontroller, a digital signal processor, a field-programmable gate array, an application-specific integrated circuit, and/or another type of processing component. The processor 520 may be implemented in hardware, firmware, or a combination of hardware and software. The processor 520 may include one or more processors capable of being programmed to perform one or more operations or processes described elsewhere herein. For example, the processor 520 may be configured to perform one or more operations included in process 300 and/or process 400.

The memory 530 may store information, one or more instructions, and/or software (e.g., one or more software applications) related to the operation of the microgrid controller 110. The memory 530 may include one or more memories that are coupled (e.g., communicatively coupled) to one or more processors (e.g., processor 520), such as via the bus 510. Communicative coupling between a processor 520 and a memory 530 may enable the processor 520 to read and/or process information stored in the memory 530 and/or to store information in the memory 530. For example, the memory 530 may store one or more power distribution schedules described elsewhere herein, and the one or more power distribution schedules may be accessed by the processor 520 for performing scheduling operations.

The input component 540 may enable the microgrid controller 110 to receive input, load information, generator data, energy storage data, status information, scheduling information, and/or control signals (e.g., control signals from a macrogrid controller). The output component 550 may enable the microgrid controller 110 to provide output, such as one or more control signals for controlling loads, energy storage systems, breakers, switches, and other components associated with the microgrid described herein. The communication component 560 may enable the microgrid controller 110 to communicate with other devices via a wired connection and/or a wireless connection. For example, the communication component 560 may include a receiver, a transmitter, and/or a transceiver.

The microgrid controller 110 may perform one or more operations or processes described herein. For example, a non-transitory computer-readable medium (e.g., memory 530) may store a set of instructions (e.g., one or more instructions or code) for execution by the processor 520. The processor 520 may execute the set of instructions to perform one or more operations or processes described herein. Execution of the set of instructions, by one or more processors 520, may cause the one or more processors 520 and/or the microgrid controller 110 to perform one or more operations or processes described herein. Hardwired circuitry may be used instead of or in combination with the instructions to perform one or more operations or processes described herein. Additionally, or alternatively, the processor 520 may be configured to perform one or more operations or processes described herein. Thus, implementations described herein are not limited to any specific combination of hardware circuitry and software.

### INDUSTRIAL APPLICABILITY

The microgrid controller may execute a power distribution schedule that enables more efficient dispatch schemes and faster dispatch times to improve an overall efficiency of the microgrid. The microgrid controller may execute the power distribution schedule based on energy resource information received from a plurality of energy resource systems associated with the microgrid to dynamically manage which energy resource systems supply power to the microgrid and which energy resource systems are disabled from supplying power to the microgrid during different time segments provided in the power distribution schedule. The microgrid controller may derive the power distribution schedule from a seed power distribution schedule to reduce processor resources of the microgrid controller required for generating and executing the power distribution schedule. A reduction in processor resources may enable the microgrid controller to dispatch instructions to one or more energy resource systems in a faster and more efficient manner to ensure a more efficient operation of the microgrid, including a more efficient distribution of power to one or more loads.

What is claimed is:

1. A microgrid controller of a microgrid, comprising:
one or more memories configured to store a power distribution schedule comprising a plurality of time segments;
a communication interface configured to receive energy resource information corresponding to a plurality of energy resource systems connected to the microgrid, and output control signals for controlling an operation of each energy resource system of the plurality of energy resource systems; and
one or more processors, coupled to the one or more memories, configured to:
monitor a current time to determine a current time segment among the plurality of time segments; and
generate the control signals based on the current time segment within the power distribution schedule to dynamically control the operation of each energy resource system of the plurality of energy resource systems, including:
assigning, based on the current time segment, each energy resource system of the plurality of energy resource systems to a plurality of groups, including a first group of energy resource systems and a second group of energy resource systems,
generating, based on the current time segment, one or more first control signals to enable the first group of energy resource systems among the plurality of energy resource systems to supply power to the microgrid, and
generating, based on the current time segment, one or more second control signals to disable the second group of energy resource systems among the plurality of energy resource systems from supplying power to the microgrid.

2. The microgrid controller of claim 1, wherein the second group of energy resource systems represent a remaining group of energy resource systems that remain after allocating one or more energy resource systems to the first group of energy resource systems.

3. The microgrid controller of claim 1, wherein the one or more processors are configured to enable the first group of energy resource systems by connecting each energy resource system of the first group of energy resource systems to a power distribution network of the microgrid, and
wherein the one or more processors are configured to disable the second group of energy resource systems by disconnecting each energy resource system of the second group of energy resource systems from the power distribution network of the microgrid.

4. The microgrid controller of claim 1, wherein the one or more processors are configured to enable the first group of energy resource systems by activating a power production at each energy resource system of the first group of energy resource systems, and
wherein the one or more processors are configured to disable the second group of energy resource systems by deactivating a power production at each energy resource system of the second group of energy resource systems.

5. The microgrid controller of claim 1, wherein the one or more processors are configured to dynamically allocate different sets of energy resource systems to the first group of energy resource systems for different time segments of the plurality of time segments.

6. The microgrid controller of claim 1, wherein the one or more processors are configured to select energy resource systems among the plurality of energy resource systems for the first group of energy resource systems based on an expected load demand on the microgrid during the current time segment in order to satisfy the expected load demand.

7. The microgrid controller of claim 1, wherein the one or more processors are configured to determine an energy resource type of each energy resource system based on the energy resource information, and allocate energy resource systems among the plurality of energy resource systems to the first group of energy resource systems based on the energy resource type of each energy resource system and based on energy resource type criteria specified in the current time segment of the power distribution schedule.

8. The microgrid controller of claim 1, wherein the one or more processors are configured to determine an output power of each energy resource system based on the energy resource information, and allocate energy resource systems among the plurality of energy resource systems to the first group of energy resource systems based on the output power of each energy resource system and based on total output power criteria specified in the current time segment of the power distribution schedule.

9. The microgrid controller of claim 1, wherein the power distribution schedule indicates an expected load condition on the microgrid for each time segment of the plurality of time segments.

10. The microgrid controller of claim 1, wherein the power distribution schedule indicates an expected grid condition on the microgrid for each time segment of the plurality of time segments.

11. The microgrid controller of claim 1, wherein the one or more processors are configured to generate one or more grid control signals for controlling a connection state of a power distribution network of the microgrid to a macrogrid, including a grid-connected state, during which the power distribution network is connected to the macrogrid for receiving power from the macrogrid, and a stand-alone state, during which the power distribution network is disconnected from the macrogrid,
wherein the one or more processors are configured to configure the microgrid in the grid-connected state or the stand-alone state based on the current time segment within the power distribution schedule.

12. The microgrid controller of claim 1, wherein the first group of energy resource systems includes a chargeable energy storage system,
wherein the one or more processors are configured to:
monitor a state-of-charge (SOC) of the chargeable energy storage system,
compare the SOC to a minimum SOC threshold,
reallocate the chargeable energy storage system from the first group to the second group based on the SOC satisfying the minimum SOC threshold, and
reallocate an energy resource system from the second group to the first group based on the SOC satisfying the minimum SOC threshold.

13. The microgrid controller of claim 12, wherein the one or more processors are configured to enable at least one auxiliary energy resource system to charge the chargeable energy storage system based on the SOC satisfying the minimum SOC threshold.

14. The microgrid controller of claim 12, wherein the one or more processors are configured to:
compare the SOC to a maximum SOC threshold,
reallocate the chargeable energy storage system from the second group to the first group based on the SOC satisfying the maximum SOC threshold, and
reallocate the energy resource system from the first group to the second group based on the SOC satisfying the maximum SOC threshold.

15. The microgrid controller of claim 1, wherein the first group of energy resource systems includes a chargeable energy storage system,
wherein the one or more processors are configured to:
monitor a state-of-charge (SOC) of the chargeable energy storage system,
compare the SOC to a minimum SOC threshold,
reallocate, based on the SOC satisfying the minimum SOC threshold, the chargeable energy storage system to the second group, and
enable, based on the SOC satisfying the minimum SOC threshold, at least one auxiliary energy resource system to supply power to the microgrid.

16. The microgrid controller of claim 1, wherein the plurality of time segments are within a 24-hour period.

17. The microgrid controller of claim 1, wherein the one or more processors are configured to receive scheduling criteria and generate the power distribution schedule based on the scheduling criteria.

18. A control method, comprising:
executing a power distribution schedule comprising a plurality of time segments;
receiving energy resource information corresponding to a plurality of energy resource systems associated with a microgrid;
monitoring a current time relative to the power distribution schedule to determine a current time segment among the plurality of time segments;
assigning, based on the current time segment, each energy resource system of the plurality of energy resource systems to a plurality of groups, including a first group of energy resource systems and a second group of energy resource systems;
generating, based on the current time segment, one or more first control signals to enable the first group of energy resource systems among the plurality of energy resource systems to supply power to the microgrid; and
generating, based on the current time segment, one or more second control signals to disable the second group of energy resource systems among the plurality of energy resource systems from supplying power to the microgrid.

19. A scheduling method, comprising:
prompting, by a human-machine interface, a selection of a first power distribution schedule as a seed schedule;
providing, by the human-machine interface, a schedule identifier of the first power distribution schedule to a microgrid controller;
extracting, by the microgrid controller, the first power distribution schedule from a schedule database based on the schedule identifier;
copying, by the microgrid controller, the first power distribution schedule as a second power distribution schedule;
reconfiguring, by the microgrid controller, the second power distribution schedule based on one or more operation parameters to generate a third power distribution schedule that includes a plurality of time segments with defined energy resource allocations for each time segment;
assigning, by the microgrid controller, based on a current time segment of the third power distribution schedule, each energy resource system of a plurality of energy resource systems to a plurality of groups, including a first group of energy resource systems and a second group of energy resource systems;
generating, by the microgrid controller, based on the current time segment, one or more first control signals to enable the first group of energy resource systems among the plurality of energy resource systems to supply power to a microgrid; and
generating, by the microgrid controller, based on the current time segment, one or more second control signals to disable the second group of energy resource systems among the plurality of energy resource systems from supplying power to the microgrid.

20. The scheduling method of claim 19, further comprising:
dynamically allocating, by the microgrid controller, different sets of energy resource systems to the first group of energy resource systems for different time segments of the plurality of time segments.
